(19) United States
(12) Patent Application Publication
(10) Pub. No.: US 2014/0183776 A1
(43) Pub. Date: Jul. 3, 2014

(54) MANUFACTURING CONCRETE

(71) Applicant: Mark Jardine, Ipswich (GB)

(72) Inventor: Mark Jardine, Ipswich (GB)

(73) Assignee: POUNDFIELD PRODUCTS LIMITED, Ipswich (GB)

(21) Appl. No.: 14/235,175

(22) PCT Filed: Jul. 24, 2012
(86) PCT No.: PCT/EP2012/064501

§ 371 Date: Feb. 11, 2014

(30) Foreign Application Priority Data
Jul. 27, 2011 (GB) GB1112878.2
Mar. 2, 2012 (GB) GB1201948.5

(51) Int. Cl. B29D 99/00

(52) U.S. Cl. CPC B29D 99/001
USPC 264/69; 264/334; 425/468

(57) ABSTRACT

A method for manufacturing hollow-core concrete slabs, the method comprising: preparing a mould by suspending in the mould between first and second end-pieces a plurality of substantially parallel elongate void formers; filling the mould with a wet concrete mix up to the crown of the void formers; laying an inert pliable filamentary sheet on the surface of the concrete with filaments of the sheet extending transverse to the long axes of the elongate void formers, the filamentary sheet being restrained so as to resist movement of the concrete mix when the void formers are withdrawn from the mix; further filling the mould with the wet concrete mix over the filamentary sheet; and, subsequently forming hollow channels in the wet concrete mix by withdrawing the plurality of void formers from the concrete mix through the second end-piece.

### BACKGROUND OF THE INVENTION

This invention relates to hollow-core concrete and methods for manufacturing hollow-core concrete.

Prefabricated hollow-core concrete slabs have been used for many years in the construction of flooring in multi-storey buildings. Typically, the concrete slabs are pre-stressed along at least their lower side by tensioned steel wire rope so as to help counterbalance the tensional forces acting on the lower side of the concrete slabs when in use. The term “hollow-core” refers to voids in the concrete that reduce the weight of the slabs, allowing them to span several metres whilst still being able to support large loads. Generally hollow-core concrete slabs are formed with multiple tubular voids that extend lengthwise through a concrete slab.

The vast majority of hollow-core concrete slabs are made by a slip-forming process that involves the extrusion of semi-dry concrete into beds laid up with pre-tensioned steel cable. Hollow-core concrete made by the extrusion or slip-forming process is typically produced as a single long slab in steel beds around 120-150 m in length. In the most advanced extrusion machines, the concrete is laid in a single pass by a large hopper that simultaneously extrudes, compacts and vibrates the concrete as it moves along the bed. At the same time, a set of metal augers are driven through the concrete beneath the hopper so as to form a set of hollow channels. This process suffers from a number of problems.

1. The extrusion process can only be used with a semi-dry concrete mix. This leads to an enormous amount of abrasion on the machine parts, particularly on the metal augers that are each driven through the entire length of the beds in order to form the hollow channels. Often these augers last only a few runs before needing to be replaced. Furthermore, the extrusion process forms a continuous long slab which must be cut into slabs of the required length by a diamond circular saw. This adds further expense since the saws must also be regularly replaced and are themselves relatively costly. In fact, it is estimated that as much as a third of the cost of producing hollow-core concrete is due to the cost of replacing the metal parts of extrusion machines and ensuring that skilled engineers are on-hand to perform the constant replacement of parts.

2. The extrusion machine requires very high power motors in order to drive the semi-dry concrete mix into the beds, to vibrate the concrete in the beds and to drive the hopper itself along the bed. Factories producing hollow-core concrete slabs by extrusion are therefore very energy intensive.

3. The factories themselves are very expensive to build due to the substantial foundations required to support the steel beds and ensure that the beds remain flat under the enormous forces produced by the extrusion machine.

4. Because the wear and tear of semi-dry concrete is so significant to the cost of the extrusion process, a softer aggregate such as limestone is typically used in the concrete mix. In areas where the local aggregate is a hard stone such as flint, this often means that softer aggregate must be shipped in at further cost in order to minimise the wear and tear on the machine. The cheaper local hard stone therefore goes unused.

5. Despite the enormous cost and complexity of the extrusion machines, the surface finish on slip-formed concrete slabs is very poor. This is largely due to the limitation that semi-dry concrete must be used. Once cured, the surface of semi-dry concrete is extremely rough, but this problem is exacerbated by the vibration used to compact the cement: the vibration drives the air in the concrete mix to the bottom of the beds resulting in large pits on the lower surface of the concrete slabs. This problem is becoming increasing significant now the industry is demanding hollow-core concrete flooring slabs whose lower surface is of sufficient quality to be simply painted in-situ and that do not need to be covered over by a soffit or layer of plaster.

6. The poor quality surface finish also affects the side walls of the concrete slab, with further degradation in quality being due to slippage of the hopper as it moves along the bed. This results in concrete slabs that have very uneven edges that do not neatly abut adjacent slabs when laid in-situ. A significant proportion of slabs are scrapped by some manufacturers due to this problem. Even if the slabs have edges of good enough quality to be used, it will typically be necessary to prepare the edges of slabs prior to use at the building site to ensure that adjacent slabs lie flush to one another. This is usually accomplished through the use of cutting equipment. Fillers are often used to plug any remaining gaps.

7. The ends of each hollow-core slab cut from a continuous slip-formed slab are also of very low quality. Since the long steel beds in which the slabs are formed are very expensive, the diamond circular saws are arranged to cut only to within around 10 mm of the bed so as to avoid damaging the steel surface. This means that each hollow-core slab must be literally snapped-off, leaving a rough edge that it is often necessary to prepare prior to use at the building site.

8. In order to add lifting points and other connections into the concrete slabs produced by the extrusion process, cut-outs must be made in the slabs to receive the connection and then the cut-out is refilled with wet concrete in order to bind the connection to the slab. Such post-fixing of connections into a slab is expensive, time-consuming and there are question marks over the safety and long-term reliability of such connections. Similarly, if any holes (e.g. to accommodate soil pipes or cabling conduits) are required in a slip-formed concrete slab, these must be made after the concrete slab has been formed. This significantly slows the rate of manufacture, results in substantial wear and tear on the cutting machinery, and requires expensive skilled labour.

This last problem has become very significant with the arrival of new building regulations that require hollow-core concrete flooring slabs to be connected into the rebar of the supporting walls (and hence most flooring slabs will require at least one connection to receive the rebar).

There are many problems with the slip-forming process. However, the alternative is to manually produce hollow-core concrete slabs using void formers to define the hollow channels, which is very slow, difficult and expensive. Typically, inflatable tubes or expanded polystyrene void formers are used, both of which are extremely buoyant in concrete and must therefore be carefully tied down whilst the concrete is poured and sets. This requires a great deal of skill and a lot of work to make each concrete slab.

Alternative methods for forming hollow-core concrete sections are to be found in the prior art but, due to severe problems with the speed and quality with which hollow-core concrete sections can be produced, these processes have fallen out of use in favour of the slip-forming method.

One such alternative method is described in UK Patent 620,750 which dates from 1946. This document describes a process for making concrete beams having a relatively narrow single longitudinal hollow core of up to 4.5 inches. In the preferred embodiment, a galvanised iron tube is located in a mould containing a set of lower reinforcing rods and into which a relatively dry concrete mix is poured up to the tops of the iron tubes. The mould is then vibrated and a strong paper is pieced atop the concrete to support a set of upper reinforcing rods (which are typically no longer used in favour of pre-stressed steel rope along only that side of the concrete beam which is to be in tension when in use). Thereafter, the mould is filled with concrete, vibrated for a second time and the iron tubes are withdrawn.

The method described in UK Patent 620,750 is suitable for making narrow beams having a single hollow core and, by using a relatively dry concrete mix, a core diameter of up to 4.5 inches can be achieved. However, using a relatively dry concrete mix leads to the wear and tear problems discussed above and to the formation of concrete beams having a poor surface finish. This process has therefore fallen out of use in favour of the slip-forming process which also uses a dry concrete mix but is faster and can be more readily scaled-up.

The patent also mentions that if a wetter concrete is to be used, or if the diameter of the cores is to be increased then the upper reinforcement (which, as discussed above, is absent from modern hollow-core concrete) can be replaced by an expanded metal sheet in order to support the concrete as it sets and prevent collapse of the cores. The metal sheet is intended to provide structural reinforcement and improve the mechanical properties of the beam. However, aside from significantly increasing the cost and weight of the finished product, in practice the use of such a sheet introduces a fault line into the cured concrete, weakening the beams made by the process and reducing the maximum load they can support. Furthermore, the use of such an expanded metal sheet runs contrary to modern building regulations which prohibit the presence of metal elements in the concrete within 20 mm of the walls of the hollow core. The method described in UK Patent 620,750 is therefore not suitable for the industrial production of modern hollow-core concrete sections.

There is therefore a need for an alternative process for forming hollow-core concrete that does not suffer from the above-mentioned problems.

### SUMMARY OF THE INVENTION

According to a first aspect of the present invention there is provided a method for manufacturing hollow-core concrete slabs, the method comprising the steps of:
preparing a mould by suspending in the mould between first and second end-pieces a plurality of substantially parallel elongate void formers;
filling the mould with a wet concrete mix up to the crown of the void formers;
laying an inert pliable filamentary sheet on the surface of the concrete with filaments of the sheet extending transverse to the long axes of the elongate void formers, the filamentary sheet being restrained so as to resist movement of the concrete mix when the void formers are withdrawn from the mix;
further filling the mould with the wet concrete mix over the filamentary sheet; and, subsequently
forming hollow channels in the wet concrete mix by withdrawing the plurality of void formers from the concrete mix through the second end-piece.

Preferably the method further comprises the step of vibrating the concrete mix prior to laying the inert pliable filamentary sheet and after the step of filling the mould. Preferably the step of vibrating the concrete mix comprises using a concrete vibrator in such a way as to move a vibrating element of the concrete vibrator through the concrete mix between the void formers. Preferably at least some of the time during the step of vibrating the concrete mix the vibrating element is in contact with the base of the mould.

Preferably the method further comprises the step of vibrating the concrete mix subsequent to the step of further filling the mould and prior to the step of forming hollow channels.

Preferably the step of laying the filamentary sheet comprises restraining the sheet by attaching the filamentary sheet to the mould.

Preferably the filamentary sheet is a mesh extending substantially across the width of the mould.

Preferably the mesh has openings at least 40 mm across and most preferably at least 50 mm across.

Preferably the mesh is a plastic mesh having a weight of less than 150 g/sq. m and preferably less than 100 g/sq. m.

Preferably the filamentary sheet is attached at least at its end opposite to the second end piece.

Preferably the step of laying the filamentary sheet comprises restraining the sheet by attaching the sheet proximal to the first end-piece.

Suitably the filaments of the filamentary sheet are not interconnected in the zone overlying the elongate void formers.

Preferably the step of laying the filamentary sheet comprises restraining the filaments by attaching the filaments proximal to the sides of the mould.

Preferably, in the step of forming hollow channels, the withdrawal of different void formers is initiated at different points in time.

Preferably, in the step of forming hollow channels, adjacent void formers are withdrawn at different points in time.

Preferably, in the step of forming hollow channels, those void formers closest to the sides of the mould are withdrawn simultaneously and prior to any other void formers.

Preferably, in the step of forming hollow channels, the withdrawal of a second void former adjacent to a first void former is not commenced until the first void former has moved at least 10 cm, preferably at least 20 cm and most preferably at least 30 cm.

Preferably the step of forming hollow channels is performed immediately once the step of further filling the mould has been completed. Alternatively the step of forming hollow channels is performed within 1 hour, preferably within 10 minutes and most preferably within 5 minutes of the step of further filling the mould being completed.

Preferably the step of forming hollow channels is performed prior to the concrete gelling.

Preferably the step of forming hollow channels comprises pulling the elongate void formers from the mould in a direction substantially along the long axis of the void formers.

Preferably the concrete mix has a water content of at least 50 litres per cubic metre and preferably at least 70 litres per cubic metre, the concrete mix further comprising approximately 1.5 litres of water-reducing plasticizer admixture.

Preferably the slump of the concrete mix is at least 100 mm and preferably at least 120 mm.

Preferably the concrete mix comprises an aggregate having a Mohs hardness of at least 4, preferably at least 5, more preferably at least 6, and most preferably at least 7.

Preferably the ratio of the total cross-sectional area of the plurality of void formers to the gross cross-sectional area of the concrete slab is at least 15%, preferably 35%, and most preferably at least 38%.

Preferably the density of the void formers within the mould is within 30%, preferably within 20% and most preferably within 15% of the density of the concrete mix.

Suitably the method further comprises, subsequent to the step of forming the hollow channels, inserting one or more fixings into the wet concrete mix.

Suitably the step of preparing the mould further comprises fixing one or more additional void formers into the mould so as to exclude the wet concrete mix from the volume(s) of the mould occupied by the one or more additional void formers.

Suitably the step of preparing the mould further comprises suspending tensioned steel cable through the mould between the base of the mould and the elongate void formers. Suitably the method further comprises, subsequent to the step of forming the hollow channels and once the concrete mix has cured, the step of cutting the tensioned steel cable at such location(s) that the resulting hollow-core concrete slab includes one or more truncated lengths of steel cable projecting out of the slab.

The method may be readily implemented and used at a building site.

According to a second aspect of the present invention there is provided apparatus for manufacturing hollow-core concrete slabs comprising:
a mould bed having a base and a pair of opposing sides;
first and second end pieces supported on the base and bounded by the opposing sides of the mould, the end pieces defining a mould therebetween;
a plurality of elongate void formers suspended between the first and second end pieces; and
a set of connecting links connectable between the elongate void formers and an engine, the connecting links being arranged so as to, in use, withdraw different void formers from the mould through the second end piece at different points in time.

Preferably the set of connecting links are arranged so as to, in use, withdraw adjacent void formers at different points in time.

Preferably the set of connecting links are arranged so as to, in use, withdraw those void formers closest to the sides of the mould simultaneously and prior to any other void formers.

Preferably the set of connecting links are arranged such that, in use, the withdrawal of a second void former adjacent to a first void former is not commenced until the first void former has moved at least 10 cm, preferably at least 20 cm and most preferably at least 30 cm.

Preferably the connecting links are ropes, chains or bungee cord.

Preferably the density of the void formers is within 30%, preferably within 20% and most preferably within 15% of the density of the concrete mix.

Preferably, in use, the end pieces are not fixed into the mould bed. Alternatively, the end pieces are connectable into the mould bed.

### DESCRIPTION OF THE DRAWINGS

The present invention will now be described by way of example with reference to the accompanying drawings, in which:

FIG. 1 is a cross-sectional view of a mould comprising a completed concrete slab in accordance with the present invention.

FIG. 2 is a top-down view of the same mould and slab as the void formers are removed.

FIG. 3 is a perspective view of the same mould and slab once the void formers have been removed.

FIG. 4 is a perspective view of an end piece according to a preferred embodiment of the present invention.

### DETAILED DESCRIPTION OF THE DRAWINGS

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to a new process for manufacturing hollow-core concrete slabs that overcomes the problems associated with conventional processes.

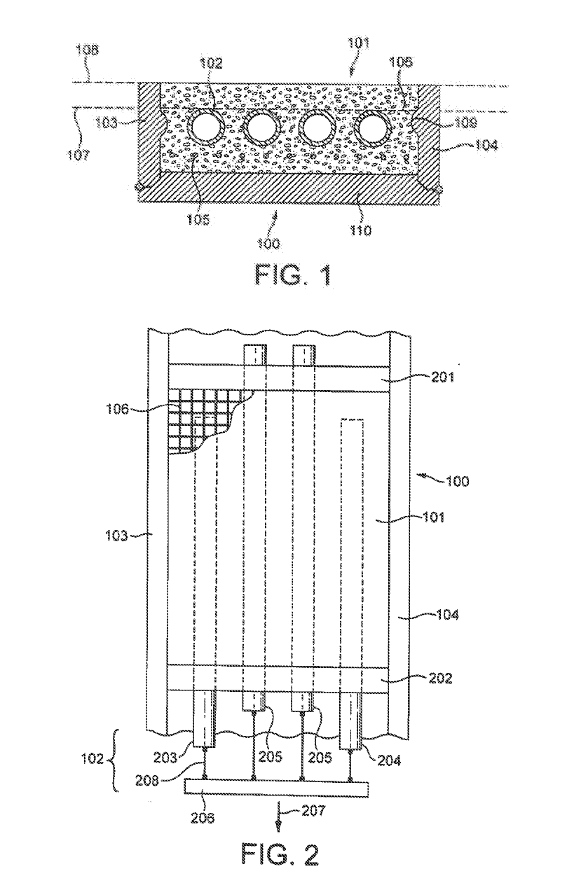

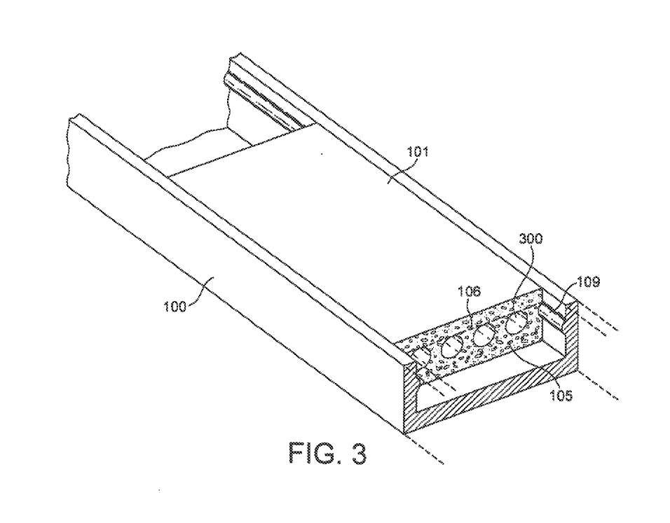

FIG. 1 is a cross-sectional view of a mould 100 comprising a completed concrete slab 101 in accordance with the present invention. FIG. 2 is a top-down view of the same mould and slab as the tubes 102 are removed. FIG. 3 is a perspective view of the same mould and slab once the tubes 102 have been removed. The formation of the concrete slab in accordance with the present invention will now be described with reference to these figures.

Mould 100 comprises a metal bed and side walls 103 and 104 into which end-pieces 201 and 202 (not shown in FIGS. 1 and 2) can be positioned so as to define concrete slabs of the desired length. As is known in the art, the side walls may include various features 109 in order to define lips and indentations in the sides of the concrete slabs and facilitate the interlocking of adjacent slabs when in situ. Preferably mould 100 is long enough to allow several concrete slabs each several metres in length to be accommodated in various stages of manufacture. The end-pieces 201 and 202 are preferably not fixed into the bed of the mould so as to allow them to be positioned at any point along the bed. The end pieces can be made of steel or a similar dense metal but their structure is not important providing they are capable of supporting a plurality of tubes for defining voids in a concrete mix poured into the mould.

Prior to pouring the concrete, mould 100 is prepared by suspending between the end pieces 201 and 202 the tubes 102 that are to define the hollow channels 300 in the concrete slab. This can be achieved by providing guide holes in the end pieces to receive the tubes. If the concrete slab is to comprise steel reinforcement, then rebar or tensioned steel cable 105 can be also placed in the mould, typically below the level of the tubes 102. For example, pre-stressed concrete flooring slabs generally comprise tensioned steel cables arranged in the lower portion of the slab so as to help counterbalance the tensional forces experienced by the lower portion of the concrete slab when in use.

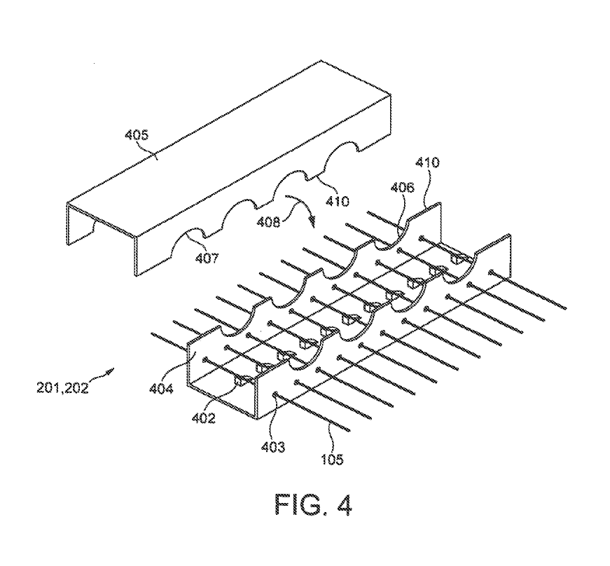

Tensioned steel cable 105 can be provided in mould 100 in the conventional manner by suspending tensioned steel cables along the length of the mould (the cables could be tensioned by a winch at one end of the mould). Preferably the steel cable passes through end-pieces 201, 202 and the end pieces are fixed relative to the steel cable such that (a) the steel cable is supported and does not significantly sag due to its weight between the two end pieces, and (b) the end pieces are held in position during pouring of the concrete. This can be achieved as shown in FIG. 4.

FIG. 4 illustrates the configuration of end pieces 201 and 202 in preferred embodiments of the present invention. Each end piece comprises an upper part 405 and a lower part 404 (shown separately in FIG. 4). Cut-outs 406 are provided in the lower part to receive the tubes 102 (not shown in FIG. 4), with corresponding cutouts being provided in the upper part such that, when the upper part is brought together with the lower part as indicated by arrow 408, the upper and lower parts sandwich the tubes 102 and form a seal along edges 410. In this manner, the tubes are held in position by the end pieces but are not rigidly fixed to the end pieces. Guide holes 403 are provided in lower part 404 through which tensioned steel cable 105 can pass through, and simple wedges 102 can be used to hold the steel cable in place relative to the lower part (and vice versa). Preferably the wedges are forced under the steel cable so as to ensure that the steel cable passes through the uppermost region of the guide holes 403. This arrangement ensures that end piece and steel cables stay in their intended position during moulding.

Once the mould has been prepared, the concrete slab is formed by the following steps:
1. Filling the mould with a wet concrete mix up to approximately the level of the top of the tubes 102 (indicated by dashed line 107 in FIG. 1) so as to just cover the crown of the tubes. Preferably the mould is partially filled up to a level above or below the top of the tubes that is within 30% of the diameter of the tubes (typically, within one or two inches). Most preferably the mould is filled up to at least the level of the top of the tubes.
2. Vibrating the concrete mix. This could be by any means of vibration or agitation that drives air pockets from the mix and ensures that the concrete properly settles around the tubes other surfaces of the mould. For example, the vibration could be achieved by vibrating the mould and/or the tubes and/or through the use of a concrete vibrator such as a hand-held vibrating wand). Preferably the concrete mix is vibrated by a concrete vibrator having a vibrating element that is small enough to pass between the tubes 102. It is particularly advantageous if the vibrating element is pushed through the concrete mix into contact with the mould base 110. This helps to drive air pockets away from the mould base and ensures that the lower major surface of the moulded concrete slab has a good quality smooth finish.
3. Laying an inert pliable mesh 10 over the surface of the concrete adjacent to tubes 102 such that, once cured, the mesh is embedded in the concrete roof of each of the hollow channels 300.
4. Completing filling of the mould with the wet concrete mix up to the desired level (indicated by dashed line 108 in FIG. 1)—this need not be to the top of the mould.
5. Vibrating at least the upper layer of concrete mix added in step 4. It is advantageous if this vibration step is performed by means of a vibrating board whose effect is to both vibrate the concrete mix and level-out the upper surface of the concrete mix (which will become the upper major surface of the concrete slab).
6. Extracting the tubes 102 from the mould by withdrawing the tubes substantially along their long axis so as to slide the tubes out of the concrete mix (this is shown in FIG. 2). This step can be performed immediately once the concrete has been poured and settled, which takes only minutes.

In less preferable embodiments, step 2 can be omitted and the concrete mix is vibrated at step 5 only. In other less preferable embodiments, step 2 can be retained but step 5 omitted.

Once the hollow-core concrete slab has cured, the finished article is extracted from the mould. This can be conveniently performed by arranging that one or both of the sides of the mould 103, 104 are hinged so as to allow the sides to be folded away and the moulded concrete slab to be lifted cleanly from the mould base 110.

The present invention allows concrete slabs to be rapidly formed from a wet concrete mix, yielding slabs of excellent surface quality. The concrete mix is wet in the sense that it could not be used to make concrete slabs by the slip-forming process. The concrete mix preferably has around 70 litres of water per cubic metre (with typically 1.5 litres of water-reducing plasticizer admixture) but up to around 120 litres of water per cubic metre could be used depending on the diameter of the tubes 102. This is to be compared with a semidry concrete mix, which typically uses less than 20 litres of water per cubic metre. Concrete mix made with 70 litres of water and 1.5 litres of water-reducing plasticizer admixture typically has a slump of around 120 mm.

The choice of aggregate in the concrete mix is not crucial to the performance of the process, but good results have been found using an aggregate size of around 14 mm. The aggregate could have a size in the range 10-20 mm. Importantly, the process described herein can be performed on an industrial scale even with hard aggregates such as flint. This is because the wear and tear on the mould parts is much less significant than is the case for slip-forming techniques. As a result, the process can make use of whichever aggregate is available most cheaply, most locally, or that is most suitable for the intended purpose of the moulded concrete slabs. The present process can be used with aggregate having a Mohs hardness of at least 7 before abrasion the machine parts becomes a significant factor.

Even if “soft” aggregate such as limestone is used, compared to the slip-forming process the present invention provides a much cheaper process by which hollow core concrete slabs can be produced because the method does not require the use of augers to drive holes through a semi-dry mix or the use of diamond circular saws to cut panels from a long moulded slab of concrete—both of which must be constantly replaced at great expense even when soft aggregates are used. Furthermore, the cutting equipment used in slip-forming factories consumes a huge volume of water for cooling and lubricating the cutting blades. This cost and wastage is also not a factor in the process of the present invention, and it also means that factories using the process of the present invention do not require the expensive cleaning equipment used in slip-forming factories to remove the waste water from the mould beds and factory floor.

The use of a mesh layer 106 in the present process allows multiple hollow channels to be immediately formed in a slab as soon as the concrete has been poured and settled. The mesh is not structural and does not significantly affect the physical properties of the concrete slabs. The role of the mesh is to prevent the layer of concrete above the tubes from slipping as the tubes are withdrawn from the mould. In FIG. 2, the tubes are shown being pulled towards end piece 202 and therefore mesh 106 is attached at least at the opposite end of the mould in order to help the upper layer of concrete moving with the tubes. Preferably the mesh is fixed at end piece 201 by means of a clamp. Most preferably the mesh is also fixed at end piece 202 and pulled taut so as to prevent the mesh sinking when the upper layer of concrete mix is added at step 4.

It is important that the mesh is largely open so as to allow the concrete mix to penetrate through the mesh and ensure that the mesh does not introduce a weakness into the concrete slab. Preferably the mesh has opening at least 40 mm in diameter and most preferably at least 50 mm in diameter. Preferably the openings represent at least 90% of the area of the mesh, and most preferably at least 95%. It is further advantageous if the mesh is pliable and flat so as to allow the mesh to roughly adopt the contours of the intermediate surface of the concrete and the tubes (107 in FIG. 1). Suitable meshes include polypropylene or nylon plastic netting having a weight of less than 150 g/sq. m and preferably less than 100 g/sq. m, such as deer fencing. The mesh is preferably not a metal in order to ensure that the finished concrete slab complies with modern building regulations and does not include any metal within 20 mm of the hollow channel walls.

Preferably mesh 106 is arranged such that filaments of the mesh are oriented transversely to the tubes 102 and extend across the mould between sides 103, 104. This is illustrated in FIG. 2, which for clarity shows just part of the mesh layer 106, in FIG. 2 the transverse filaments of the mesh are orthogonal to the axes of the tubes 102: this is preferably but not essential, and the mesh could be arranged such that the transverse filaments are at an angle to the axes of the tubes of other than 90 degrees. FIG. 2 also shows the mesh extending to the side of the mould: this is not essential provided that the mesh substantially covers the tubes 102.

In an alternative embodiment, layer 106 instead comprises a layer of filaments oriented across the mould transverse to the axes of the tubes 102, the filaments not being interconnected so as to form a mesh. Preferably the transverse filaments are orthogonal to the axes of the tubes 102 but the mesh could be arranged such that the transverse filaments extend between the sides of the mould at an angle to the axes of the tubes of other than 90 degrees. In this alternative embodiment the filaments are fixed at the sides 103 and 104 of the mould—for example, by clamping the ends of the filaments. Suitable filament materials are described above in relation to the use of a mesh.

Since the mesh stabilises the layer of concrete mix above the level of the tubes and prevents the wet mix moving with the tubes as they are withdrawn, the present invention allows the tubes to be withdrawn as soon as the concrete has been poured and settled. A hollow-core concrete slab can therefore be formed in minutes before being left to cure. This releases equipment used in the process (e.g. the concrete hopper, vibrators and tubes) and the workers operating the equipment to start work on the next slab. By providing long beds on which multiple moulds can be arranged and by having multiple beds, the process can be readily scaled up to industrial levels of production. Furthermore, compared to slip-forming processes the power requirements of the process are far lower, the equipment is far cheaper, and the cost of producing mould beds is much less expensive because extensive foundations are not required to support them. Hollow-core concrete factories using the process disclosed herein are therefore much cheaper to build and run.

Of course, it is possible to wait for some time before withdrawing the tubes—typically until around the point at which the concrete starts to gel and the surface of the concrete can be touched without leaving a residue of concrete on the fingers. For standard concrete slab sizes of 6×1.2×0.2 m this occurs at around one hour. Waiting for the concrete to gel first can allow concrete slabs having even greater tube diameters to be produced by the method of the present invention. However, this slows down the rate at which slabs can be produced and hence increases the unit cost of the slabs.

It is advantageous if the density of the tubes is chosen to be similar to the density of the concrete. This avoids the tubes sinking or floating as they are withdrawn from the mould. The density of the tubes can be readily chosen by using tubes of a material that is itself more dense than the concrete mix but which are hollow such that the net density of the tubes in the mould (ignoring any parts of the tubes that do not pass through the concrete mix during withdrawal) is similar to the density of the concrete mix displaced. For example, the tubes could be hollow steel tubes whose density (of the steel plus the central hollow void it defines) is similar to that of the wet concrete mix. The density of wet concrete is typically around 2400 kilos per cubic metre and hollow cylindrical steel tubing can be arranged to have a similar density through appropriate choice of wall thickness and/or the use of ballast (steel having a density of around 8000 kilos per cubic metre). For example, hollow cylindrical steel tubing having an external diameter of 140 mm and a wall thickness of 6 mm can be arranged to have a net density of 2700 kilos per cubic metre through the addition of appropriate ballast. It has been found that tubes having a net density within around 15% of the density of the concrete mix can be withdrawn from the mould without the path of the tubes suffering significant deviation due to buoyancy effects. In less preferred embodiments the tubes could be solid.

Furthermore, the stiffness of the tubes 102 should be sufficient to substantially resist bending of the tubes during pouring of the concrete (when the weight of the concrete dropping onto the tubes can be significant), settling of the concrete (when the upthrust due to the settling concrete can be significant) and withdrawal of the tubes (when, as discussed above, the buoyancy of the tubes in the concrete mix can be significant).

As a further measure to avoid the slippage of the layer of concrete above the tubes when the tubes are withdrawn from the mould, it is advantageous to arrange that not all of the tubes are withdrawn at the same time. Preferably the outside tubes closest to the sides of the mould (203 and 204 in FIG. 2) are withdrawn first, followed by the central tubes 205 in any order. Most preferably adjacent tubes are not withdrawn at the same time. For example, for a slab having eight hollow channels formed by eight tubes numbered 1 to 8 according to their position across the mould, the outside tubes 1 and 8 might be withdrawn first, followed by tubes 2, 4 and 6 being withdrawn together, and then tubes 3, 5 and 7 being withdrawn together.

A much greater force is initially required to withdraw the tubes than to maintain the movement of the tubes out of the mould. It is therefore advantageous if the means for withdrawing the tubes is configured to initially apply a greater force than is subsequently used to maintain the movement of the tubes out of the mould. For example, this can be arranged by attaching the tubes to a winch by means of a flexible connection (such as a chain, rope, or bungee cord) that is longer than is required to connect the pulling means to the tubes. In this example, the winch is started and the slack in the flexible connections to the tubes is taken in at high speed by the winch such that when each connection becomes taut the respective tube is “yanked” from the mould. By arranging that different tubes have different length connections to the winch, a single winch can be used to pull different tubes at different moments in time. In this example, the tubes are pulled from the mould but in other embodiments the tubes could be pushed from the mould—for example, by a thin rod.

Preferably, once the tubes have stopped accelerating, the speed of withdrawal of the tubes is at least walking pace—typically about 4 mph. If the speed of withdrawal is substantially slower than this the tubes can drag some of the concrete mix in the direction in which the tubes are being withdrawn, resulting in a misshapen concrete slab.

The present process readily allows concrete slabs to be produced that have cut-out portions (e.g. for soil pipes or cabling conduits) or end walls that are not orthogonal to the side walls of the mould. Such slabs are often required in the construction of modern buildings. This can be achieved by inserting additional void formers into the mould to blank off portions of the mould as required by the shape that is to be produced. These void formers could comprise, to give a couple of examples, metal sheets attached across the mould, or pieces of wood or polystyrene fashioned so as to define the required shape. In order to accommodate the tubes running through the mould, the void formers could be provided in two or more parts—one or more parts to be laid beneath the tubes and one or more parts to be laid above the tubes. Alternatively the void formers could be provided with the appropriate holes to allow the tubes to pass through them. As is known in the art, void formers can be held in place in the mould through the use of magnets positioned in the void formers and beneath the base or on the sides of the mould.

Because the present process uses a wet concrete mix, fixings can be readily provided in the cured concrete slabs without requiring further processing of the slabs after curing. Fixings such as sockets for rebar, lifting points and other features can be simply pushed into the wet cement mix and left to bond into the concrete as it cures.

Because slabs produced according to the present invention are spaced apart on a mould bed by at least the width of the end pieces, concrete slabs comprising tensile reinforcement can be arranged to readily provide structural connections to other slabs and building components. This can be achieved by unevenly cutting the tensile reinforcement running through two cured slabs adjacent on the mould bed such that each slab retains at least one length of tensile reinforcement projecting from the slab. For example, in the case of eight tensioned steel cables running along the mould, the steel cables can be cut between adjacent slabs such that one of the slabs retains a length of cables 1, 3, 5, 7 and the other slab retains a length of cables 2, 4, 6, 8. The lengths of cable can be used to structurally connect each slab into the building in which it is to be used.

Concrete slabs produced in accordance with the present invention can be manufactured with hollow channels at least 140 mm in diameter. This is significantly larger than is possible with conventional wet mix techniques of similar speed. Furthermore, the method of production described herein does not require that the concrete slabs are provided with an upper layer of tensile reinforcement, above the level of the void-forming tubes. The method is therefore particularly suitable for making pre-stressed concrete floor panels products for which there is substantial demand in the industry.

It has been noted that factories equipped to perform the process described herein are cheaper to build and run than factories which manufacture hollow-core concrete panels using the slip-forming technique. Since the void-forming tubes can be withdrawn from the mould immediately, the technique is as fast as the predominant slip-forming method. Finally, because the process uses wet-mix concrete, the surface quality of the concrete panels formed in accordance with the method of the present invention is vastly improved over that of concrete panels formed by a slip-forming process.

A person skilled in the art of hollow-core concrete manufacture can readily distinguish between concrete that has been formed using a semi-dry process (e.g. from a semi-dry concrete mix, as in the case of slip-forming concrete panels) and concrete that has been formed using a wet process (e.g. from a wet concrete mix in accordance with the present process). Wet-formed concrete has a significantly different internal structure in terms of the size of its internal flaws and the nature and degree of the coating of the aggregate and sand with cement. In fact, dry-formed cement requires significantly more cement in the mix in order to achieve the same mechanical strength in the finished product.

Furthermore, wet-formed concrete has a significantly different surface finish (in wet-formed concrete the cement in the mix migrates to the surface to give a very high quality smooth finish). The surface roughness of wet-formed concrete is significantly less than that formed from a semi-dry mix. For example, an average surface roughness of less than a millimetre is possible with wet-formed concrete, whereas the average surface roughness of concrete formed from a semi-dry mix is of the order of several millimetres (if not centimetres) due to the large number of surface imperfections.

The surface finish of concrete panels formed according to the present invention—in particular, the lower surface formed next to the mould bed—is in fact so good that, once in situ, the panels can be simply painted and do not require a cosmetic layer of plaster or soffit.

Finally, because hollow-core panels produced according to the present invention are reliably of higher quality, the panels can be produced to tighter tolerances and as a result lighter slabs can be engineered to support the same loads that, if produced by a slip-forming process, would require thicker and heavier slabs.

In the figures accompanying the examples described herein, the tubes are hollow cylinders. However, the tubes could be elongate void formers of any cross-section and need not be hollow. Preferably the crown of the void formers (that part located uppermost in the mould) is arched since, once the void formers have been removed, this shape can support the largest diameter voids in the concrete.

Means for withdrawing the void formers may be any kind of machine for pulling or pushing the void formers out of the mould, including a winch system or other arrangement of motors (electric, combustion, or otherwise) a set of hydraulic or pneumatic pistons.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for manufacturing hollow-core concrete slabs, the method comprising:
preparing a mould by suspending in the mould between first and second end-pieces a plurality of substantially parallel elongate void formers;
filling the mould with a wet concrete mix up to the crown of the void formers;
laying an inert pliable filamentary sheet on the surface of the concrete with filaments of the sheet extending transverse to the long axes of the elongate void formers, the filamentary sheet being restrained so as to resist movement of the concrete mix when the void formers are withdrawn from the mix;
further filling the mould with the wet concrete mix over the filamentary sheet; and, subsequently
forming hollow channels in the wet concrete mix by withdrawing the plurality of void formers from the concrete mix through the second end-piece.

2. A method as claimed in claim 1, further comprising vibrating the concrete mix prior to laying the inert pliable filamentary sheet and after filling the mould.

3. A method as claimed in claim 2, wherein vibrating the concrete mix comprises using a concrete vibrator in such a way as to move a vibrating element of the concrete vibrator through the concrete mix between the void formers and wherein at least some of the time during vibrating the concrete mix the vibrating element is in contact with the base of the mould.

4. (canceled)

5. A method as claimed in claim 1, further comprising vibrating the concrete mix subsequent to further filling the mould and prior to forming hollow channels.

6. A method as claimed in claim 1, wherein laying the filamentary sheet comprises restraining the sheet by attaching the filamentary sheet to the mould.

7. A method as claimed in claim 1, wherein the filamentary sheet is a mesh extending substantially across the width of the mould and wherein the mesh has openings at least 40 mm across and most preferably at least 50 mm across.

8. (canceled)

9. A method as claimed in claim 1, wherein the mesh is a plastic mesh having a weight of less than 150 g/sq. m and preferably less than 100 g/sq. m.

10. A method as claimed in claim 1, wherein the filamentary sheet is attached at least at its end opposite to the second end piece, wherein laying the filamentary sheet comprises restraining the sheet by attaching the sheet proximal to the first end-piece, and wherein laying the filamentary sheet comprises restraining the filaments by attaching the filaments proximal to the sides of the mould.

11. (canceled)

12. A method as claimed in claim 1, wherein the filaments of the filamentary sheet are not interconnected in the zone overlying the elongate void formers.

13. (canceled)

14. A method as claimed in claim 1, wherein, in forming hollow channels, the withdrawal of different void formers is initiated at different points in time.

15. A method as claimed in claim 1, wherein, in forming hollow channels, at least one of the following is performed:
withdrawing adjacent void formers at different points in time;
withdrawing those void formers closest to the sides of the mould simultaneously and prior to any other void formers; and
not commencing withdrawal of a second void former adjacent to a first void former until the first void former has moved at least 10 cm, preferably at least 20 cm and most preferably at least 30 cm.

16. (canceled)

17. (canceled)

18. A method as claimed in claim 1, wherein forming hollow channels is performed immediately once further filling the mould has been completed or within 1 hour, preferably within 10 minutes and most preferably within 5 minutes of further filling the mould being completed.

19. (canceled)

20. A method as claimed in claim 1, wherein forming hollow channels is performed prior to the concrete gelling and wherein forming hollow channels comprises pulling the elongate void formers from the mould in a direction substantially along the long axis of the void formers.

21. (canceled)

22. A method as claimed in claim 1, wherein the concrete mix has a water content of at least 50 litres per cubic metre and preferably at least 70 litres per cubic metre, the concrete mix further comprising approximately 1.5 litres of water-reducing plasticizer admixture, and wherein the slump of the concrete mix is at least 100 mm and preferably at least 120 mm.

23. (canceled)

24. A method as claimed in claim 1, wherein the concrete mix comprises an aggregate having a Mohs hardness of at least 4, preferably at least 5, more preferably at least 6, and most preferably at least 7 and wherein the ratio of the total cross-sectional area of the plurality of void formers to the gross cross-sectional area of the concrete slab is at least 15%, preferably 35%, and most preferably at least 38%.

25. (canceled)

26. (canceled)

27. A method as claimed in claim 1, further comprising, subsequent to forming the hollow channels, inserting one or more fixings into the wet concrete mix and wherein preparing the mould further comprises fixing one or more additional void formers into the mould so as to exclude the wet concrete mix from the volume(s) of the mould occupied by the one or more additional void formers.

28. (canceled)

29. A method as claimed in claim 1, wherein preparing the mould further comprises suspending tensioned steel cable through the mould between the base of the mould and the elongate void formers and further comprising, subsequent to forming the hollow channels and once the concrete mix has cured, cutting the tensioned steel cable at such location(s) that the resulting hollow-core concrete slab includes one or more truncated lengths of steel cable projecting out of the slab.

30. (canceled)

31. (canceled)

32. Apparatus for manufacturing hollow-core concrete slabs comprising:
a mould bed having a base and a pair of opposing sides;
first and second end pieces supported on the base and bounded by the opposing sides of the mould, the end pieces defining a mould therebetween;
a plurality of elongate void formers suspended between the first and second end pieces; and
a set of connecting links connectable between the elongate void formers and an engine, the connecting links being arranged so as to, in use, withdraw different void formers from the mould through the second end piece at different points in time.

33. Apparatus as claimed in claim 32, wherein the set of connecting links are arranged so as to, in use, withdraw adjacent void formers at different points in time.

34. Apparatus as claimed in claim 32, wherein the set of connecting links are arranged so as to, in use, withdraw those void formers closest to the sides of the mould simultaneously and prior to any other void formers.

35. Apparatus as claimed in claim 32, wherein the set of connecting links are arranged such that, in use, the withdrawal of a second void former adjacent to a first void former is not commenced until the first void former has moved at least 10 cm, preferably at least 20 cm and most preferably at least 30 cm.
